(19) United States
(12) Patent Application Publication
(10) Pub. No.: US 2025/0172314 A1
(43) Pub. Date: May 29, 2025

(54) ENERGY-RECOVERY VENTILATOR AND MOUNTING SYSTEM THEREFORE

(71) Applicant: BROAN-NUTONE LLC, Hartford, WI (US)

(72) Inventors: Richard R. Sinur, Hartford, WI (US); Bradley Mergener, Hartford, WI (US); Brent Lillesand, Hartford, WI (US); Ryan Revers, Hartford, WI (US)

(21) Appl. No.: 18/935,817

(22) PCT Filed: May 24, 2023
(86) PCT No.: PCT/US2023/067382

§ 371 Date: Nov. 4, 2024

Related U.S. Application Data
(60) Provisional application No. 63/346,402, filed on May 27, 2022.

(51) Int. Cl. F24F 12/00

(52) U.S. Cl. CPC F24F 12/006; F24F 2221/20

(57) ABSTRACT

An energy-recovery ventilator system is configured to be mounted to a window of a building. The energy-recovery ventilator system includes an energy recovery ventilator configured to exchange air and including an indoor ventilator section arranged to lie on an indoor side of the window, an outdoor ventilator section arranged to lie on an outdoor side of the window, and a ventilator manifold extending between and interconnecting the indoor ventilator section and the outdoor ventilator section.

### PRIORITY CLAIM

This application claims priority under 35 U.S.C. § 119 (e) to U.S. PCT Application Serial No. US23/067382, filed May 24, 2023 and Provisional Application Ser. No. 63/346,402, filed May 27, 2022, which is expressly incorporated by reference herein.

### BACKGROUND

The present disclosure relates to an air handling unit, and particularly to a window-mounted air handling unit. More particularly, the present disclosure relates to a window-mount energy recovery ventilation unit.

### SUMMARY

According to the present disclosure, an energy-recovery ventilator system is configured to be mounted to a window of a building. The energy-recovery ventilator system includes an energy recovery ventilator and a ventilator mount. The energy-recovery ventilator is configured to exchange air and includes an indoor ventilator section arranged to lie on an indoor side of the window, an outdoor ventilator section arranged to lie on an outdoor side of the window, and a ventilator manifold extending between and interconnecting the indoor ventilator section and the outdoor ventilator section.

In some embodiments, the ventilator mount includes an attachment system fixed to a window frame of the window and extending between the indoor side and the outdoor side. The ventilator mount may further include a ventilator platform coupled to the attachment system for movement between a collapsed position and a horizontal-use position supporting the indoor ventilator section of the energy recovery ventilator. The ventilator mount may further include a load leg coupled to a bottom surface of the ventilator platform and configured to extend between the ventilator platform and an interior wall of the building below the window to support the ventilator platform in the horizontal-use position.

In accordance with another aspect of the present disclosure, a window-mounted, energy-recovery ventilator includes an indoor ventilator section, an outdoor ventilator section, and a ventilator manifold extending between and interconnecting the indoor ventilator section and the outdoor ventilator section. The indoor ventilator section includes a first housing coupled to the ventilator platform and an indoor portion of the ventilator manifold, a first blower arranged to lie within a first interior space defined by the first housing, and an energy-exchange unit arranged to lie within the first interior space. The outdoor ventilator section includes a second housing coupled to an outdoor portion of the ventilator manifold and a second blower arranged to lie within a second interior space defined by the second housing.

In some embodiments, the first housing is spaced apart from the second housing to define a pane-receiving space therebetween. The pane-receiving space may be configured to receive a window pane of a window to locate a portion of the window pane between the first housing and the second housing and to locate the window pane above a midsection of the ventilator manifold.

In accordance with another aspect of the present disclosure, an air handling unit system is configured to be mounted to a window of a building. The air handling unit system includes an air handling device configured to produce and discharge conditioned air into an interior room of the building.

In some embodiments, the air handling unit system further includes a mount system configured to attach to a window frame of the window and support the air handling device relative to the window. The mount system may include an adjustable attachment system configured to attach directly to the window frame, a device platform mounted to the adjustable attachment system and configured to support the air handling device in a horizontal-use position, and a load leg coupled to a bottom surface of the device platform and configured to extend between the device platform and an interior wall of the building below the window to support the device platform in the horizontal-use position

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of an energy-recovery ventilator system mounted to a window of a building;

FIG. 2 is a cross section of the energy-recovery ventilator system showing an exhaust air flowpath through the system;

FIG. 2A is a perspective view of a ventilator manifold which is structured to provide the exhaust air flowpath through the system;

FIG. 3 is a cross section of the energy-recovery ventilator system showing a fresh air flowpath through the system;

FIG. 3A is a perspective view of the ventilator manifold which is structured to provide the fresh air flowpath through the system;

FIG. 4A is a perspective view of an ventilator mount included in the energy-recovery ventilation system and used to mount an energy-recovery ventilator to the window;

FIG. 4B is a perspective view of an expandable divider wall included in the energy-recovery ventilation system;

FIG. 4C is a perspective view of a canister of expandable foam insulation being used to fill an interior of the expandable divider wall;

FIG. 5 is a cross section of the ventilator mount attached to the window;

FIG. 6 is a perspective view showing an energy-recovery ventilator being installed on the ventilator mount;

FIG. 7 is a perspective view of the energy-recovery ventilation system including an indoor air quality system;

FIG. 8 is another perspective view of the energy-recovery ventilation system;

FIG. 9 is a perspective and cross sectional view of the energy-recovery ventilation system;

FIG. 10 is another perspective and cross sectional view of the energy-recovery ventilation system;

FIG. 11 is another perspective view of the ventilator mount;

FIG. 12 is a perspective view of another embodiment of a ventilation system; and

FIG. 13 is another perspective view of the ventilation system from FIG. 12.

### DETAILED DESCRIPTION

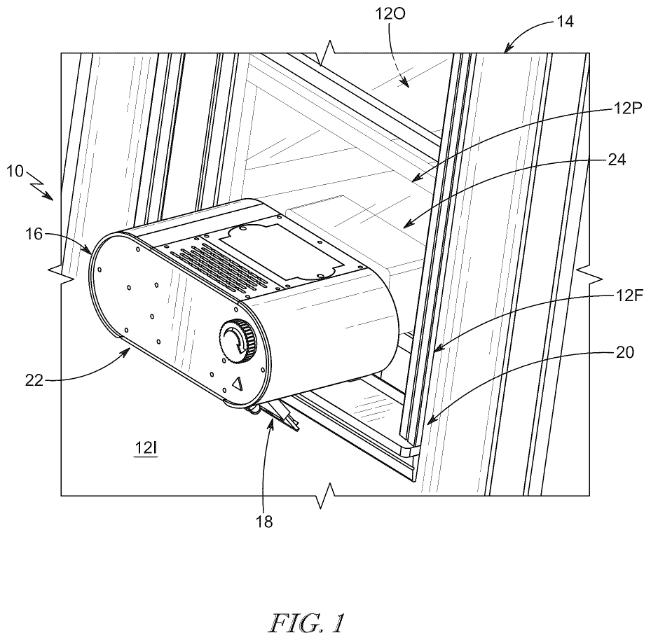

An energy-recovery ventilator system 10 is configured to be mounted to a window 12 of a building 14 to ventilate and/or condition air within a room of the building 14 where the window 12 is located as shown in FIGS. 1-3. The energy-recovery ventilator system 10 includes an energy recovery ventilator 16 and a ventilator mount 18. The energy recovery ventilator 16 is configured to exchange indoor air located within the building 14 with outdoor air located outside the building 14. The ventilator mount 18 is fixed to a window frame 12F of the window 12 and is configured to mount the energy recovery ventilator 16 in position within an opening 20 provided by the window 12 so that the energy recovery ventilator 16 can exchange the indoor air with the outdoor air.

The energy recovery ventilator 16 includes an indoor ventilator section 22 arranged to lie on an indoor side 12I of the window 12 and an outdoor ventilator section 24 arranged to lie on an outdoor side 12O of the window 12 as shown in FIGS. 1-3. The indoor ventilator section 22 and the outdoor ventilator section 24 are connected to one another by a ventilator manifold 26 that extends between and interconnects the indoor ventilator section 22 and the outdoor ventilator section 24.

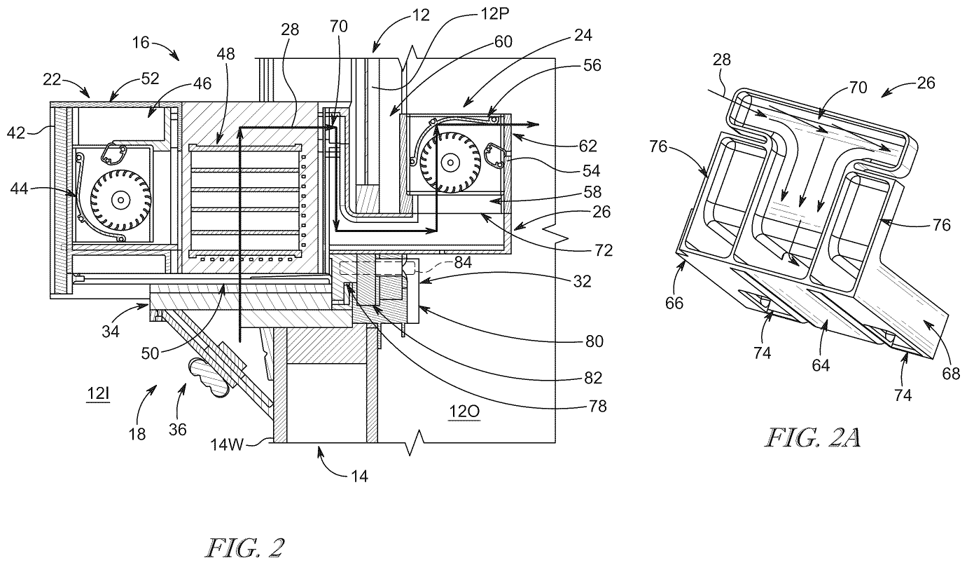

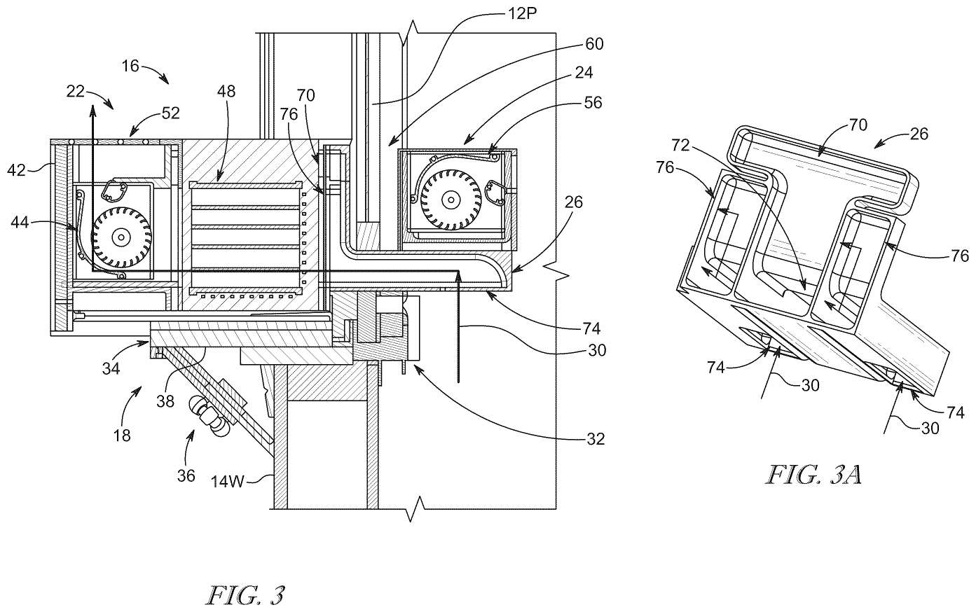

Together, the indoor ventilator section 22, the outdoor ventilator section 24, and the ventilator manifold 26 define an exhaust air flowpath 28, as shown in FIG. 2, and a separate supply air flowpath 30, as shown in FIG. 3. The exhaust air flowpath discharges indoor air from the indoor side 12I of the window 12 to the outside of the building 14. The supply air flowpath 30 draws outdoor air from the outdoor side 12O of the window 12 and discharges the outdoor air into the building 14. In this way, the energy recovery ventilator 16 is configured to ventilate at least one room of the building 14 with fresh outdoor air.

The ventilator mount 18 includes an attachment system 32 for being fixed to the window frame 12F of the window 12, a ventilator platform 34 coupled to the attachment system 32, and a load leg 36 coupled to a bottom surface 38 of the ventilator platform 34 as shown in FIGS. 2 and 3. The attachment system 32 extends between the indoor side 12I and the outdoor side 12O and provides a clamping force on portions of the window frame 12F to fix the ventilator mount 18 to the window 12. The ventilator platform 34 may be fixed to the attachment system 32 or movable relative to the attachment system 32.

For example, the ventilator platform 34 is configured to support the energy recovery ventilator 16 in a horizontal-use position. In the horizontal-use position, the indoor ventilator section 22 of the energy recovery ventilator 16 is supported by the ventilator platform 34 on the indoor side 12I of the window 12. The load leg 36 is configured to extend between the ventilator platform 34 and an interior wall 14W of the building 14 below the window 12 to support the ventilator platform 34 in the horizontal-use position.

The indoor ventilator section 22 includes a first housing 42 coupled to the ventilator platform 34 and an indoor portion of the ventilator manifold 26, a first blower 44 arranged to lie within a first interior space 46 defined by the first housing 42, and an energy-exchange unit 48 arranged to lie within the first interior space 46. The first housing 42 is exposed within the room of the building 14 and may include various controls or buttons to operate the energy recovery ventilator 16. The first housing 42 also defines an exhaust intake 50 which admits indoor air into the exhaust air flowpath 28 and a supply outlet 52 which discharges fresh outdoor air into the building 14. The exhaust intake 50 and the supply outlet 52 may be covered by a screen, grate, filter, etc. The first blower 44 is configured to displace outdoor air through the supply air flowpath 30 and through the supply outlet 52 into the building 14. The energy-exchange unit 48 is positioned along both the exhaust air flowpath 28 and the supply air flowpath 30 and is configured to exchange energy (i.e. heat and/or moisture) between the indoor air and the outdoor air to minimize energy losses from the building 14.

The energy-exchange unit 48 includes energy-exchange media that defines a first plurality of energy-exchange passageways along the exhaust air flowpath 28 and a second plurality of energy-exchange passageways along the supply air flowpath 30. As indoor air flows through the first plurality of energy-exchange passageways the energy-exchange media absorbs heat and/or moisture from the indoor air. As outdoor air flows through the second plurality of energy-exchange passageways, the energy-exchange media releases or transfers the heat and/or moisture to the outdoor air before it is discharges into the building 14.

The energy-exchange media is also capable of absorbing heat and/or moisture from the outdoor air prior to being released into the building 14 depending on climate conditions outside the building and/or settings made to the energy-recovery ventilator 16. In the illustrative embodiment, the first plurality of energy-exchange passageways extend in a vertical direction and the second plurality of energy-exchange passageways extend in a horizontal direction, perpendicular to the vertical direction. The energy-recovery unit 48 may also include one or more filters that can be removed and discarded or cleaned.

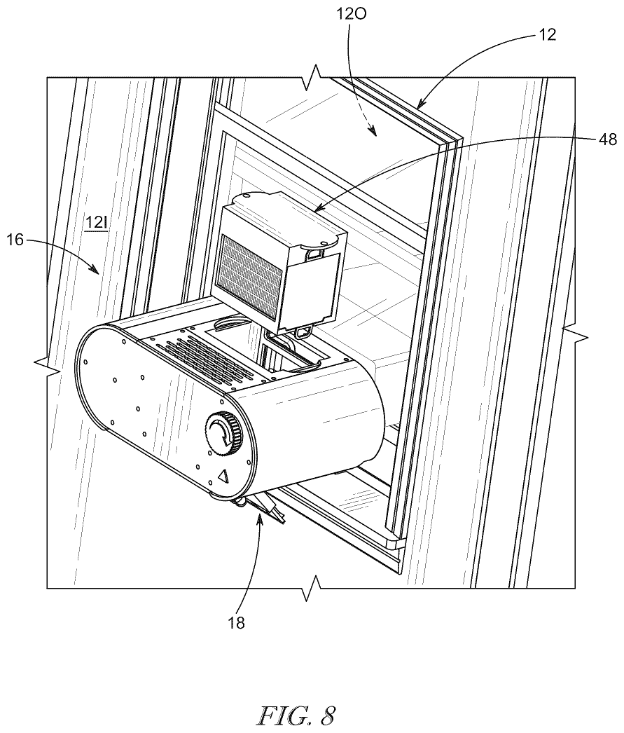

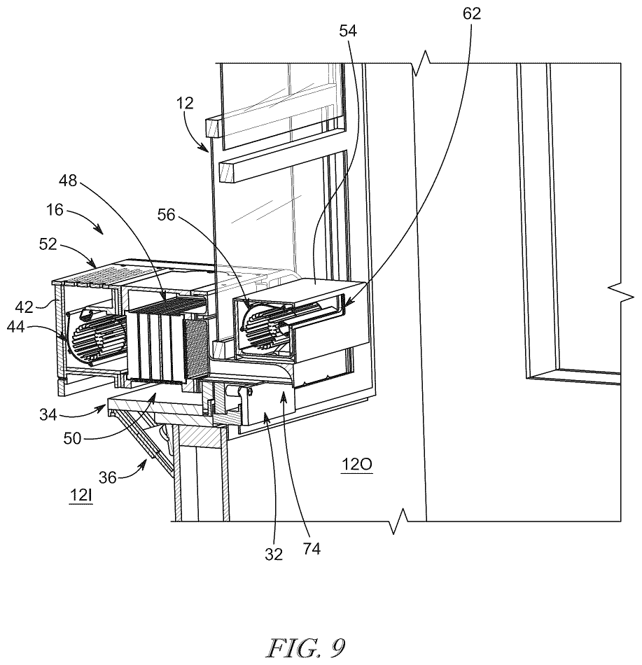

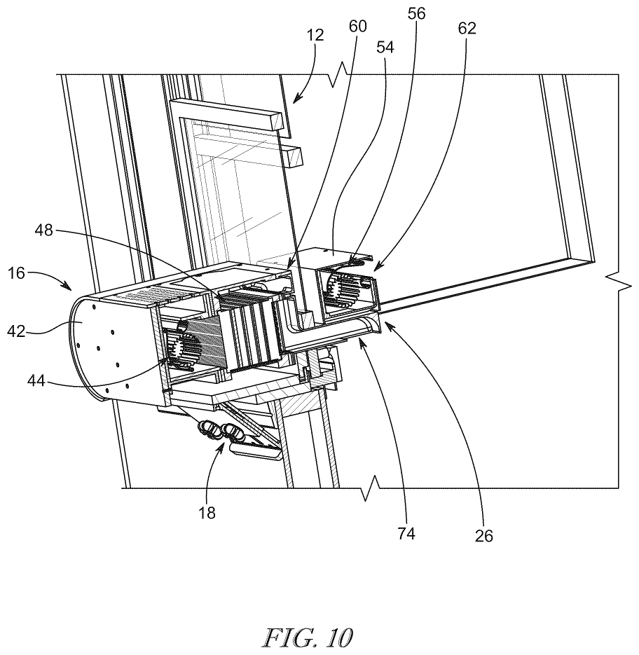

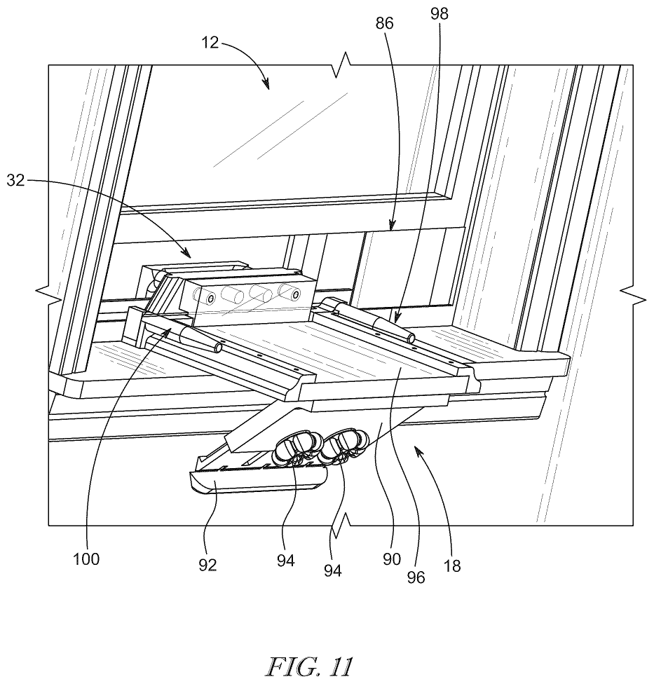

The energy-recovery unit 48 is located within the indoor space of the building 14 so as to be accessible to occupants in the building 14. The energy-recovery unit 48 can be removed from the housing 44 of the indoor ventilator section 22 for service and/or cleaning as shown in FIG. 8. The energy-exchange unit 48 is also located in the indoor ventilator section 22 as opposed to outdoor ventilator section 24 so as to be located in a conditioned, indoor space to minimize a possibility of the unit freezing.

The outdoor ventilator section 24 includes a second housing 54 coupled to an outdoor portion of the ventilator manifold 26 and a second blower 56 arranged to lie within a second interior space 58 defined by the second housing 54. The second housing 54 is positioned above the outdoor portion of the ventilator manifold 26 and defines an exhaust outlet 62 which discharges the indoor air from the exhaust air flowpath 28 into space outside the building 14. The second blower 56 is configured to displace indoor air through the exhaust air flowpath 28 and through the exhaust outlet 62 into the space outside building 14. The exhaust outlet 62 is spaced apart from supply inlet openings 74 of the supply flowpath 30 to minimize recirculation of air discharged from the exhaust outlet 62 and back into the inlet openings 74. The exhaust outlet 62 is also formed into a vertical wall of the outdoor ventilator section 24 to minimize entry of rain or other falling particles while maintaining spacing from inlet openings 74.

The first housing 42 is spaced apart from the second housing 54 in a horizontal direction to define a pane-receiving space 60 therebetween. The pane-receiving space 60 is configured to receive a window pane (including window sash) 12P of the window to locate a portion of the window pane 12P between the first housing 42 and the second housing 54. The window pane 12P is also located above a midsection of the ventilator manifold 26. Both the exhaust air flowpath 28 and the supply air flow path 30 include portions which extend beneath and perpendicular to the window pane 12P and parallel to the window pane 12P through the ventilator manifold 26.

The ventilator manifold 26 is generally L-shaped when viewed from the side to partially define the pane-receiving space 60. The ventilator manifold 26 includes an exhaust conduit 64 partially defining the exhaust air flowpath 28, and a pair of supply conduits 66, 68 partially defining the supply air flowpath 30 as shown in FIGS. 2A and 3A. The exhaust conduit 64 is located between the supply conduits 66, 68. A cumulative volume of the exhaust conduit 64 is about equal to a cumulative volume of both the supply conduits 66, 68 combined so that flowrates in the exhaust and supply flowpaths 28, 30 are about equal.

The exhaust conduit 64 defines a T-shaped inlet opening 70 that faces toward the energy-recovery unit 48 and receives the indoor air therefrom. The exhaust conduit also defines a rectangular shaped outlet opening 72 that faces and opens toward the second blower 54. Both of the supply conduits 66, 68 define rectangular shaped inlet openings 74 that face the space outside the building 14 and rectangular shaped outlet openings 76 that face the energy-recovery unit 48. The outlet opening 72 of the exhaust conduit 64 opens in an opposite direction away from the inlet openings 74 of the supply conduits 66, 68. The inlet opening 70 of the exhaust conduit 64 and the outlet openings 76 of the supply conduits open in the same direction toward the energy-recovery unit 48. The inlet openings 74 of the supply conduits 66, 68 face downwardly in the direction of gravity to minimize entry of rain or other particles. Although the openings are shown and described as being rectangular in shape, it should be appreciated that any suitable shape may be used for the openings.

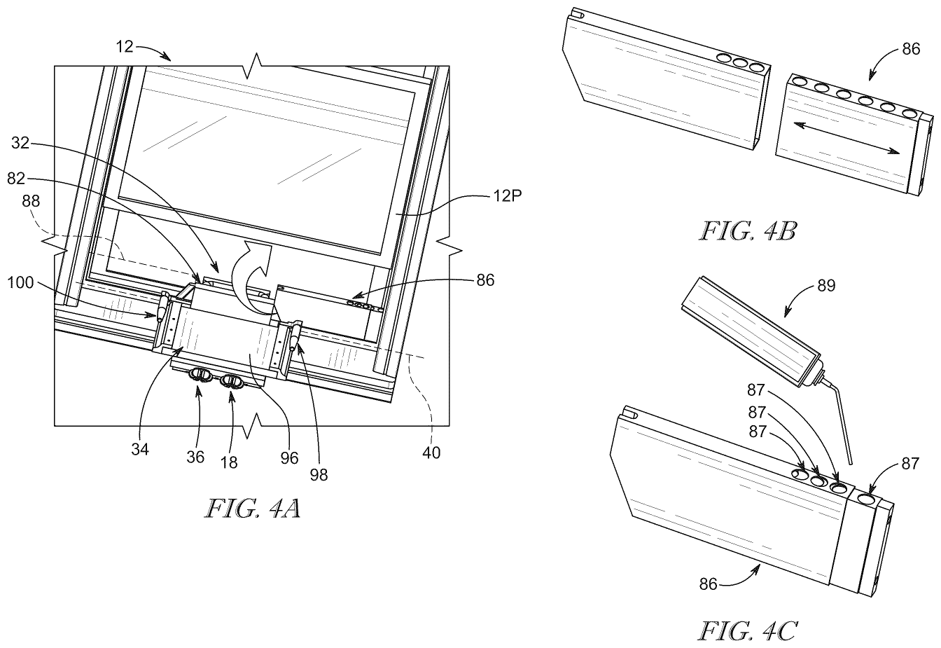

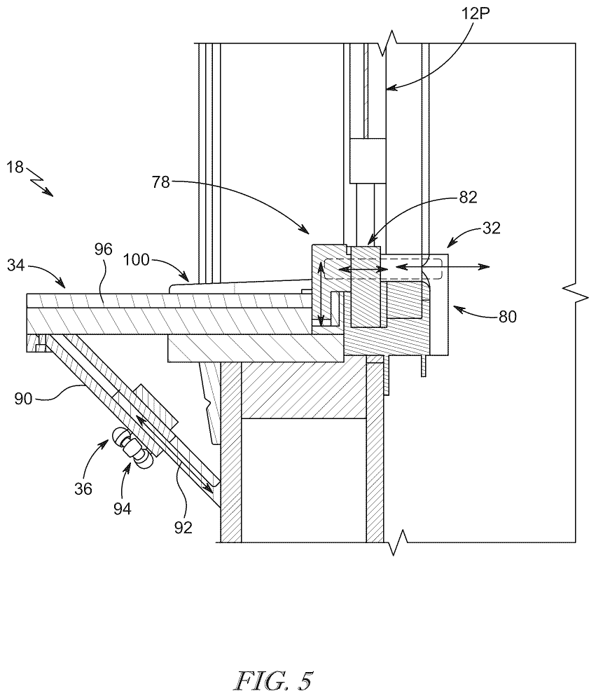

The attachment system 32 is configured to grip onto a bottom strip of the window frame 12F as shown in FIGS. 1-5. The attachment system 32 includes a front clamp member 78, a rear clamp member 80, and a spacer 82. The front clamp member 78 is arranged to lie on the indoor side 12I of the window and is configured to engage a front flange of the bottom strip of the window frame 12F. The rear clamp member 80 is arranged to lie on the outdoor side 12O of the window 12 and is configured to engage a rear flange of the bottom strip of the window frame 12F. The spacer 82 is arranged to lie within a space defined between the front flange and the rear flange of the bottom strip of the window frame 12F. One or more fasteners 84 (e.g. screws or bolts) are configured to be inserted through apertures formed in the front clamp member 78, the rear clamp member 80, and the spacer 82. The fasteners 84 may be used to apply tension between the front clamp member 78 and the rear clamp member 80 to fix the attachment system 32 to the bottom strip of the window frame 12F. The spacer 82 fills gaps formed between a bottom of the window pane 12P and the bottom strip of the window frame 12F to provide a barrier between an indoor area of the building 14 and space outside the building 14.

The spacer 82 may extend along the entire width of the bottom strip of the window frame 12F and the window pane 12P to form a barrier along the entire width. In some embodiments, the spacer 82 may extend only partway alone the width. In such instances, the energy recover ventilation system 10 may further include a first expandable divider 86 and a second of expandable divider 88 that cooperate with the spacer 82 to form the barrier between the indoor area and the space outside the building 14. The first expandable divider 86 is arranged to lie between the bottom surface of the window pane 12P and the bottom strip of the window frame 12F on a first lateral side of the attachment system 32. The second expandable divider 88 is arranged to lie between the bottom surface of the window pane 12P and the bottom strip of the window frame 12F on an opposite, second lateral side of the attachment system 32. The attachment system 32 (and, hence, the spacer 82) are located laterally between the first and second expandable dividers 86, 88.

When closed, the bottom surface of the window pane 12P engages upper ends of the first and second dividers 86, 88, the spacer 82, and the ventilator manifold 26 to form seals therebetween so that air is blocked from passing therebetween. Inclusion of the pane-receiving space 60 allows a height of the first and second dividers 86, 88 and of spacer 82 to be minimized for increased thermal insulation and aesthetics of the window 12 and the energy-recovery ventilator system 10.

In some embodiments, the first and second expandable dividers 86, 88 each include a plurality of segments that are slidable and/or expandable relative to one another to increase or decrease a lateral width of the dividers 86, 88. In this way, the energy-recovery ventilation system 10 can accommodate windows of variable widths. In the illustrative embodiment, the plurality of segments each have a rectangular cross section with varying areas to telescopically fit within on another when collapsed. One or more of the segments may include frangible portions 87 that are removable from the segments to provide an opening into a cavity of each expandable divider 86, 88 so that the cavity of each expandable divider 86, 88 can be filled with an insulative material from a canister 89, for example. The spacer 82 can also include similar frangible portions and can be filled with insulative material.

The load leg 36 is adjustable relative to the ventilator platform 34 to accommodate variable building structures (i.e. wall thicknesses). The load leg includes a leg mount 90, a leg foot 92, and a foot retainer 94 as shown in FIGS. 1-5. The leg mount 90 is fixed to the bottom surface 38 of the ventilator platform 34. The leg foot 92 is coupled to the leg mount 90 and is slidable relative to the leg mount 90 between a collapsed position and one or more extended positions to increase or decrease the overall length of the load leg 36. The foot retainer 94 is configured to lock the leg foot 92 relative to the leg mount 90 so that the load leg 36 extends between the ventilator platform 34 and the wall 14W of the building 14 to bear loads acting on the ventilator platform 34 from the energy-recovery ventilator 16.

The foot retainer 94, in the illustrative embodiment, includes at least one rotatable knob coupled in a fixed position to the leg mount 90 and that, when rotated in a loosening direction, releases a pin from the leg foot 92 so that the leg foot 92 is free to slide relative to the leg mount 90. Subsequent rotation of the knob in a tightening direction, opposite the loosening direction, engages the pin with the leg foot 92 to block the leg foot 92 from sliding relative to the leg mount 90.

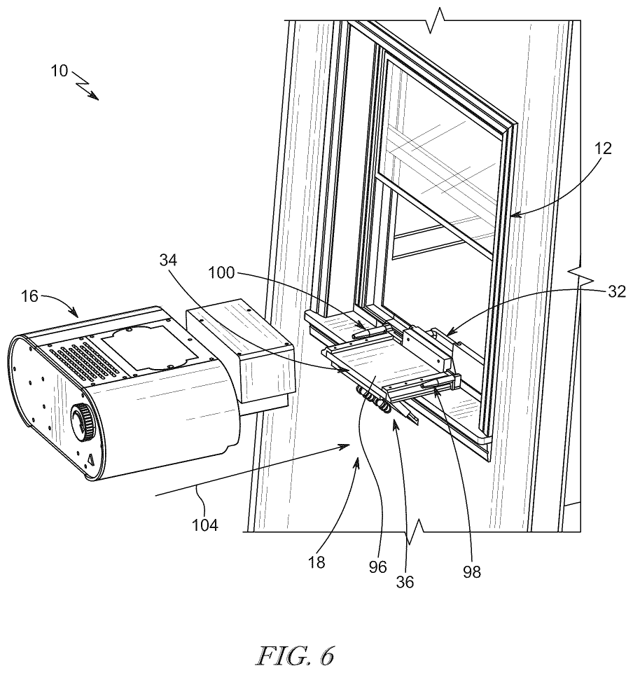

The ventilator platform 34 supports the energy recovery ventilator 16 relative to the window 12 so that the indoor section 22 is arranged on the indoor side 12I and the outdoor section 24 is arranged on the outdoor side 12O. The ventilator platform 34 includes a platform base 96 and left and right ventilator mount posts 98, 100. The load leg 36 is coupled to the platform base 96. The energy-recovery ventilator 16 is configured to slide onto the ventilator mount posts 98, 100 to attach thereto. In the illustrative embodiment, the energy-recovery ventilator 16 slides in a direction 104 toward the window 12 from inside the building 14 as suggested in FIG. 6. In this way, the energy-recovery ventilator 16 is installed while the installer is inside the building 14 as opposed to standing on a ladder and installing the ventilator from outside the building 14. In some embodiments, the mount posts 98, 100 may have a different structure such as rails, snaps, or slots, for example. The energy recovery ventilator 16 and/or the mount posts 98, 100 may include a lockable/releasable feature which retains the energy recovery ventilator 16 to the mount posts 98, 100 in an installed position. The lockable/releasable feature may be a spring clip in some embodiments. The lockable/releasable feature is actuatable to remove the energy recovery ventilator 16 from the mount system 18 for storage, for example.

The platform base 96 may be a solid piece of material or may be formed to include one or more openings that open toward the exhaust intake 50. The left and right ventilator mount posts 98, 100 may be located above a plane of the platform base 96 so that, when the energy-recovery ventilator 16 is installed on the ventilator mount 18, spacing is provided between at least a portion of the energy-recovery ventilator 16 and the ventilator platform 34 so that air can flow to the exhaust intake 50.

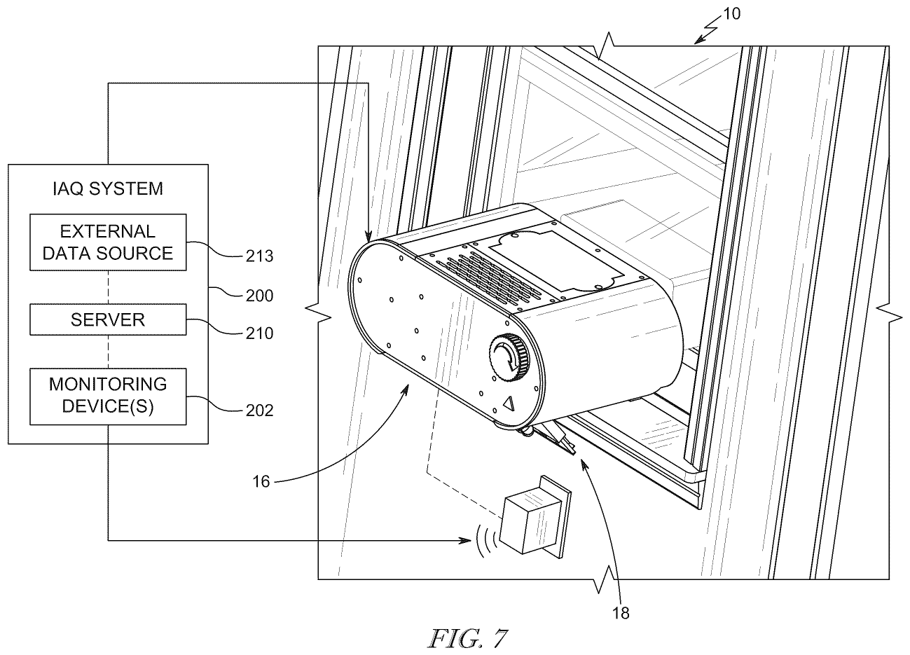

The energy-recovery ventilation system 10 may be included as part of an indoor air quality (IAQ) system 200 that includes one or more monitoring devices 202 as shown in FIG. 7. The monitoring devices 202 are configured to sense and record IAQ data from an indoor environment of the building 14. The IAQ data includes temperature, humidity and/or pollutant levels, such as TVOC, CO2, PM2.5. The IAQ data may be recorded on a local server/database 210 included in the IAQ system 200. A plurality of connected appliances, including the energy-recovery ventilator 16, are operated based on the sensed IAQ data. The energy recover ventilator 16 may include its own sensor(s) which can determine IAQ data or conditions of the energy recovery ventilator itself. For example, the energy recovery ventilator 16 may include a sensor which is used to measure indoor temperature, humidity, dew point, and/or pollutant levels, such as TVOC, CO2, PM2.5. The energy recovery ventilator 16 may also include a sensor for sensing conditions where the energy-exchange unit 48 is at risk for freezing. The energy recovery ventilator 16 can use signals from all of these sensors to adjust its operation (i.e. on/off, flow rate, etc).

The IAQ system 200 may also be capable of obtaining outdoor air quality index (AQI) data external to the structure (e.g. weather, smoke, fog, temperature, humidity, dew point, and/or pollutant levels, such as TVOC, CO2, PM2.5) from various locations surrounding the building 14 to compare with the IAQ data obtained within the building 14. The AQI data may be obtained from an external data source 213. The connected appliances, including the energy-recovery ventilator 16, are then operated in response to the sensed IAQ data from the monitoring devices 202 and the AQI data from the external data source 213. In some embodiments, the AQI data is calculated by and obtained from a government entity (e.g. the United States or Canada) such as the US National Oceanic and Atmospheric Administration (NOAA).

When included in the IAQ system 200, the energy-recovery ventilator 16 acts as a ventilation or fresh air system, including both a supply and exhaust fan, for at least one room of the building 14. The monitoring device 202 includes at least one sensor, which it uses to collect data about the local environment of the building. Some or all of this IAQ data is then sent to the local server/database 210, which processes and stores this data. If the local server/database 210 determines that one level contained within the IAQ data is out of the predetermined threshold range, then the IAQ system 200 may be configured to operate one or more of the appliances, including the energy-recovery ventilator 16, to adjust the level. If the local server/database 210 determines that levels contained in the AQI data are outside of the predetermined threshold ranges, the IAQ system 200 may further operate one or more of the appliances to bring indoor air levels within certain ranges in response to the AQI data. The energy-recovery ventilator 16 in the illustrative embodiment can be used with the IAQ system 10 described in U.S. Provisional Patent Application No. 63/335,246, filed on Apr. 27, 2022, which is expressly incorporated by reference herein in its entirety.

Although the present disclosure is directed toward an energy recovery ventilator 16, it should be appreciated that the mount 18 can be used with any window-mounted air handling device. Accordingly, the energy-recovery ventilator system 10 may be referred to as an air handling unit system 10 that is configured to be mounted to a window 12 of a building 14. The air handling unit system 10 includes an air handling device 16 configured to produce and discharge conditioned air into an interior room of the building, and a mount system 18 configured to attach to a window frame 12F of the window 12 and support the air handling device 16 relative to the window 12. The air handling device 16 may be a window-mounted, air-conditioning unit, a window-mounted heater, a window-mounted air purifier, a window-mounted humidifier, a window-mounted dehumidifier, or any other air handling unit.

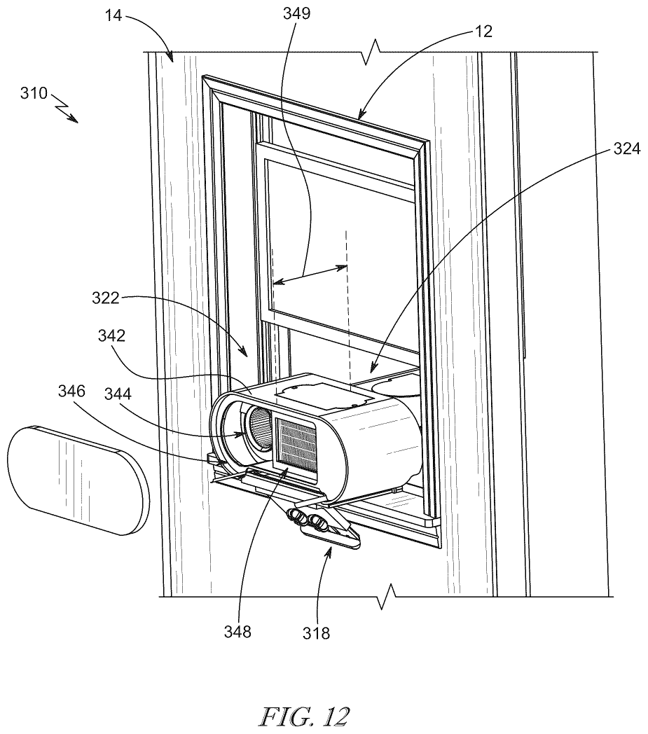

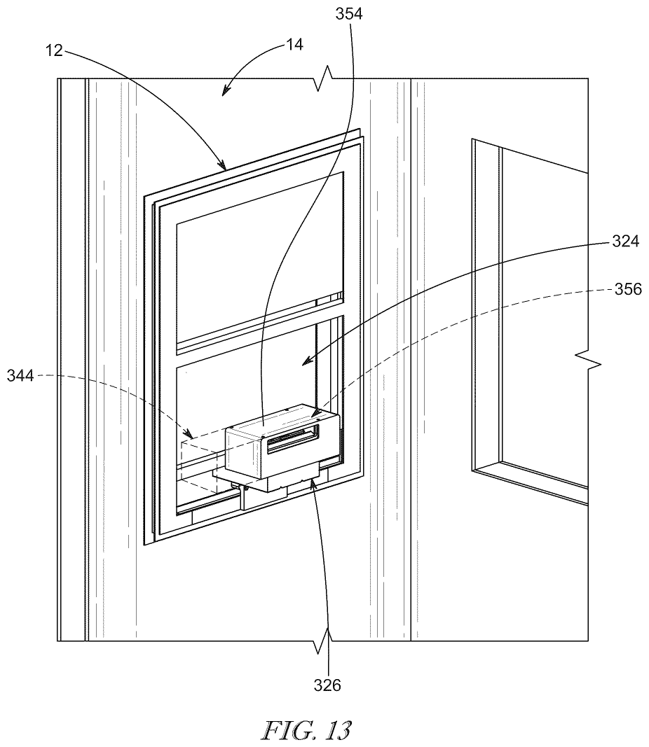

Another embodiment of a window-mounted energy-recovery ventilator system 310 is shown in FIGS. 12 and 13. The energy-recovery ventilator system 310 is substantially similar to energy-recover ventilator system 10. Accordingly, similar reference numbers in the 300 series are used to reference similar features between energy-recovery ventilator system 10 and energy-recovery ventilator system 310. The disclosure of energy-recovery ventilator system 10 is incorporated by reference herein for energy-recovery ventilator system 310.

The energy-recovery ventilator system 310 includes an energy recovery ventilator 316 and a ventilator mount 318. The energy recovery ventilator 316 is configured to exchange indoor air located within the building 14 with outdoor air located outside the external to the building 14. The ventilator mount 318 is fixed to the window frame 12F of the window 12 and is configured to mount the energy recovery ventilator 316 in position within an opening provided by the window 12 so that the energy recovery ventilator 316 can exchange the indoor air with the outdoor air.

The energy recovery ventilator 316 includes an indoor ventilator section 322 arranged to lie on an indoor side 12I of the window 12 and an outdoor ventilator section 324 arranged to lie on an outdoor side 12O of the window 12 as shown in FIGS. 12 and 13. The indoor ventilator section 322 and the outdoor ventilator section 324 are connected to one another by a ventilator manifold 326 that extends between and interconnects the indoor ventilator section 322 and the outdoor ventilator section 324.

The indoor ventilator section 322 includes a first housing 342 coupled to the ventilator mount 318 and an indoor portion of the ventilator manifold 326, a first blower 344 arranged to lie within a first interior space 346 defined by the first housing 42, and an energy-exchange unit 348 arranged to lie within the first interior space 346. The first housing 342 is exposed within the room of the building 14 and may include various controls or buttons to operate the energy recovery ventilator 316. The first blower 344 is configured to displace outdoor air through a supply air flowpath into the building 14. The energy-exchange unit 348 is configured to exchange energy (i.e. heat and/or moisture) between the indoor air and the outdoor air to minimize energy losses from the building 14.

The first blower 344 is a centrifugal fan and is positioned on a lateral side of the energy-exchange unit 348 as shown in FIG. 12. Positioning the first blower 344 to the side of the energy-exchange unit 348 (as opposed to directly in-front of the energy-exchange unit as shown in FIG. 2, for example) allows a width 349 of the indoor section 322 to be decreased. The decreased width 349 of the indoor section 322 results in a ventilator 310 that protrudes into the room of the building 14 at a reduced distance. Centrifugal fans may also operate at a higher rate compared to other types of fans such as a scroll-type fan, for example, thereby resulting in greater ventilation capabilities of the system.

The outdoor ventilator section 324 includes a second housing 354 coupled to an outdoor portion of the ventilator manifold 326 and a second blower 356 arranged to lie within a second interior space 358 defined by the second housing 354. The second blower 356 may also be a centrifugal fan, like the first blower 344, so that the flow rates through the ventilator are about equal. In some embodiments, the first blower 344 can be located within the second interior space 358 of the second housing 354 (i.e. in the outdoor ventilator section 324). Positioning both blowers 344, 356 in the outdoor ventilator section 324 may further decrease the width 349 of the indoor ventilator section 322.

1. An energy-recovery ventilator system configured to be mounted to a window of a building, the energy-recovery ventilator system comprising
an energy recovery ventilator configured to exchange air and including an indoor ventilator section arranged to lie on an indoor side of the window, an outdoor ventilator section arranged to lie on an outdoor side of the window, and a ventilator manifold extending between and interconnecting the indoor ventilator section and the outdoor ventilator section, and
a ventilator mount including an attachment system fixed to a window frame of the window and extending between the indoor side and the outdoor side, a ventilator platform coupled to the attachment system for movement between a collapsed position and a horizontal-use position supporting the indoor ventilator section of the energy recovery ventilator, and a load leg coupled to a bottom surface of the ventilator platform and configured to extend between the ventilator platform and an interior wall of the building below the window to support the ventilator platform in the horizontal-use position.

2. The energy-recovery ventilator system of claim 1, wherein the indoor ventilator section includes a first housing coupled to the ventilator platform and an indoor portion of the ventilator manifold, a first blower arranged to lie within a first interior space defined by the first housing, and an energy-exchange unit arranged to lie within the first interior space.

3. The energy-recovery ventilator system of claim 2, wherein the outdoor ventilator section includes a second housing coupled to an outdoor portion of the ventilator manifold and a second blower arranged to lie within a second interior space defined by the second housing.

4. The energy-recovery ventilator system of claim 3, wherein first housing is spaced apart from the second housing to define a pane-receiving space therebetween, the pane-receiving space is configured to receive a window pane of the window to locate a portion of the window pane between the first housing and the second housing and to locate the window pane above a midsection of the ventilator manifold.

5. The energy-recovery ventilator system of claim 4, further comprising a first expandable divider and a second of expandable divider, the first expandable divider is arranged to lie between a bottom surface of the window pane and the window frame on a first lateral side of the attachment system, and the second expandable divider is arranged to lie between the bottom surface of the window pane and the window frame on a second lateral side of the attachment system.

6. The energy-recovery ventilator system of claim 5, wherein the first and second expandable dividers each include frangible portions that are removable to provide an opening into a cavity of each expandable divider so that the cavity of each expandable divider can be filled with an insulative material.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. The air handling unit system of claim 17, wherein the expandable divider includes frangible portions that are removable to provide an opening into a cavity of each expandable divider so that the cavity of each expandable divider can be filled with an insulative material.

19. The air handling unit of claim 11, wherein the manifold includes a supply section and an exhaust section separate from the supply section, the supply section defines a supply passageway that extends from a supply intake that opens into an outdoor area to a supply outlet that opens toward the indoor section, and the exhaust section defines an exhaust passageway that extends from an exhaust intake that opens toward one or more exhaust-air passageways to an exhaust outlet that opens toward the outdoor section.

20. The air handling unit of claim 19, wherein supply passageway is a first supply passageway and the supply section of the ventilator manifold further defines a second supply passageway, the first supply passageway is positioned on a first side of the exhaust passageway and the second supply passageway is positioned on a second side of the exhaust passageway.
